(19) United States
(12) Patent Application Publication
(10) Pub. No.: US 2010/0020554 A1
(43) Pub. Date: Jan. 28, 2010

(54) Greenhouse Lighting System

(75) Inventor: Teunis Cornelis van den Dool, Monster (NL)

Correspondence Address: TROUTMAN SANDERS LLP;BANK OF AMERICA PLAZA, 600 PEACHTREE STREET, N.E., SUITE 5200, ATLANTA, GA, 30308-2216, US

(73) Assignee: Hortilux Schreder B.V., Monster (NL)

(21) Appl. No.: 12/439,658

(22) PCT Filed: Sep. 11, 2007
(86) PCT No.: PCT/NL07/00221

§ 371 Date: Mar. 31, 2009

(30) Foreign Application Priority Data
Sep. 14, 2006 (NL) 1032497

(51) Int. Cl. F21V 19/00

(52) U.S. Cl. 362/382

(57) ABSTRACT

A greenhouse lighting system comprising a greenhouse lighting fitting having a lamp holder (370) with an outer ring (371) provided in a cavity in the lamp holder; which can be electrically connected to a phase, and an assimilation lamp (140, 240, 340) which comprises a lamp cap (142, 242, 342) and a bulb and can be screwed into the lamp holder via an insertion opening. The greenhouse lighting system comprises an electrically insulating gasket (100, 200, 300) which is situated around the lamp cap of the assimilation lamp in such a manner that the lamp cap can no longer be touched with a finger when the lamp cap contacts the outer ring.

The present invention relates to a greenhouse lighting system comprising a greenhouse lighting fitting having a lamp holder with an outer ring provided in a cavity in the lamp holder, which is electrically connectable to a phase and a via an insertion opening screwable assimilation lamp which comprises a lamp cap and a bulb.

Such greenhouse lighting systems are generally known. The lamp holder of the greenhouse lighting fitting generally has a housing provided with a cavity inside which a metal outer ring is placed. The outer ring can be electrically connected to a power supply, so that a voltage is applied to the outer ring.

An assimilation lamp, such as a high-pressure sodium lamp or a metal halogen lamp, generally has a lamp cap with a metal screw fitting which corresponds to the screw thread of the outer ring. The assimilation lamp can be inserted into the lamp holder and screwed in.

Due to the generally known safety instructions, a fitter is expected to switch off the voltage before fitting or replacing a lamp.

It is an object of the invention to increase the safety of the system, so that undesirable situations while fitting or replacing a lamp are prevented.

It is a further object of the present invention to provide a usable alternative to the known greenhouse lighting system. In particular, it is an object of the present invention to provide a greenhouse lighting fitting in which lamps can be fitted and removed safely.

This object is achieved by a greenhouse lighting system according to the invention, as defined in claim 1.

Characteristic of the invention is the fact that the greenhouse lighting fitting furthermore comprises an electrically insulating gasket which is situated around the lamp cap of the assimilation lamp in the greenhouse lighting system in such a manner that the lamp cap can no longer be touched with a finger when the lamp cap contacts the outer ring, in particular while the lamp is being screwed in or unscrewed.

The invention is based on the insight that the known systems may give rise to dangerous situations if the fitter omits to switch off the voltage. While the lamp is being screwed in or unscrewed, part of the lamp cap will be outside the housing of the lamp holder while the outer ring which is under voltage still contacts the lamp cap. If the fitter accidentally touches this exposed part of the lamp cap, this could result in an electric shock.

The presence of the electrically insulating gasket around the lamp cap ensures that the lamp cap cannot be touched with a finger during fitting of the assimilation lamp into the lamp holder or the removal of the assimilation lamp from the lamp holder, as long as the lamp cap still makes contact with the outer ring in the lamp holder. The space between the bulb and the lamp holder is filled by the gasket in such a manner that it is no longer accessible to a finger of a fitter.

Preferably, the gasket extends at least partially between the bulb and the outer ring of the lamp holder. In a particular embodiment, the gasket and the outer ring partially overlap. The gasket does not have to cover the entire sleeve surface which extends outside the housing of the lamp holder. Part of the sleeve surface of the lamp cap can remain exposed, as long as the gasket ensures that this exposed region cannot be touched accidentally by the fitter.

In one embodiment according to the invention, the gasket is completely outside the lamp holder.

In a preferred embodiment, the gasket at least partly extends as far as into the lamp holder. Preferably, the lamp holder is provided with a groove, into which the gasket can be placed. In that case, the dimensions of the gasket are such that the gasket adjoins the lamp holder in a sealing manner.

Further particular embodiments are described in the other subclaims.

The invention furthermore relates to a greenhouse lighting fitting, an assembly of a lamp holder and gasket and to an assimilation lamp provided with a gasket.

The invention will be explained in more detail with reference to the accompanying drawings which show a practical embodiment of the invention, but which should not be regarded as being limiting, in which:

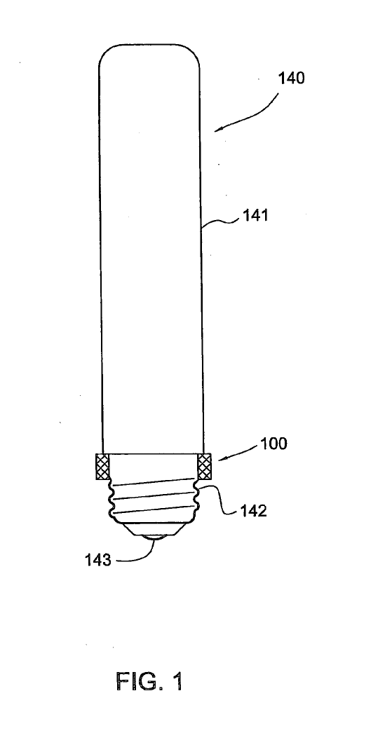

FIG. 1 shows a diagrammatic side view of an assimilation lamp with a gasket;

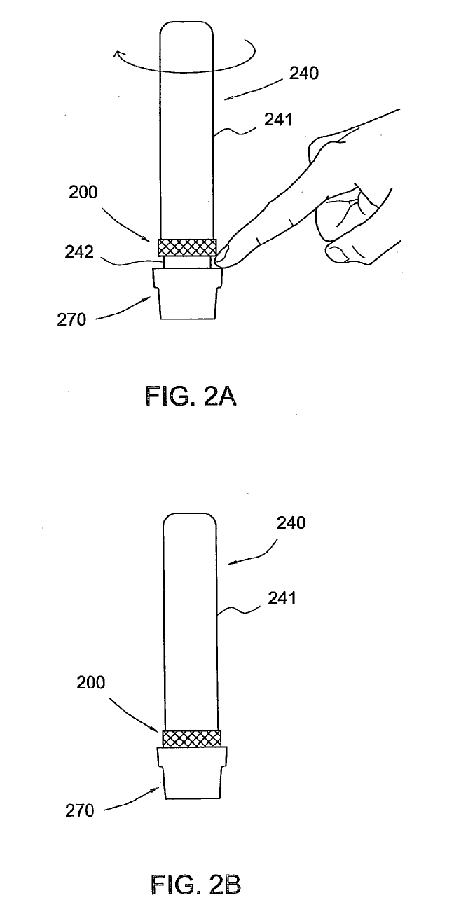

FIGS. 2a-2b diagrammatically show how an assimilation lamp is placed in a lamp holder;

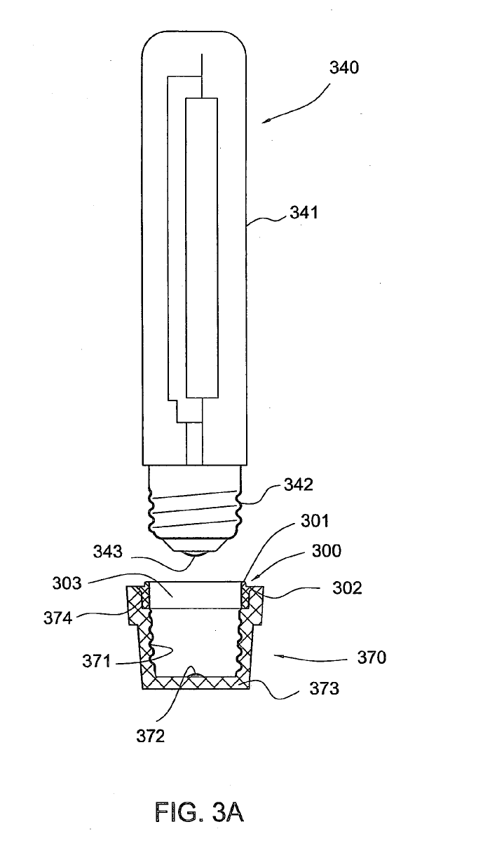

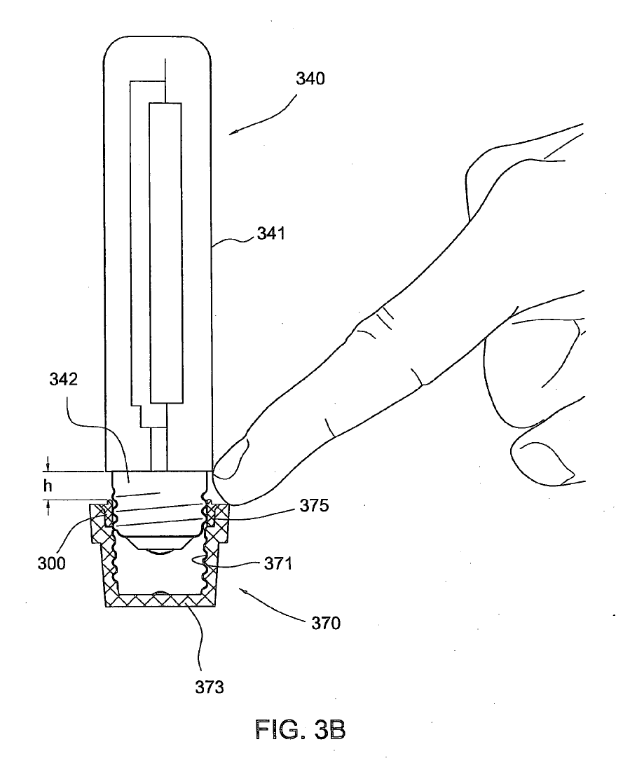

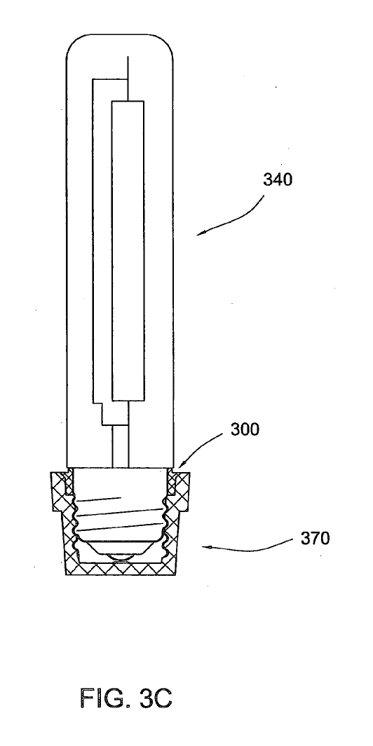

FIGS. 3a-3c diagrammatically and in cross section show how an assimilation lamp is placed in a lamp holder;

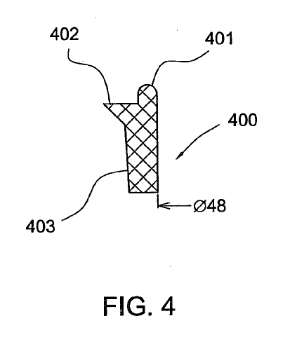

FIG. 4 shows a cross section of a gasket according to the invention.

FIG. 1 diagrammatically shows a side view of an assimilation lamp 140 which comprises a lamp cap 142 which is attached to a bulb 141. The lamp cap 142 is provided with a screw thread for attachment to a lamp holder suitable for the purpose. At the distal end of the lamp cap 142, there is a contact point 143. By connecting an electrical phase to the sleeve surface of the lamp cap 142 and providing an electrical connection at the contact point 143, the assimilation lamp 140 will light up.

Furthermore, a gasket 100 is provided around the lamp cap 142. The gasket 100 in this case adjoins the sleeve surface of the lamp cap 142 and an end side of the bulb 141. The gasket 100 is made of an electrically insulating material. The gasket 100 in this case has a rectangular cross section.

FIGS. 2a and 2b diagrammatically show the stages when an assimilation lamp 240 is screwed into a lamp holder 270. FIG. 2a shows a hand with a finger pointing in the direction of a danger zone near the lamp cap 242. When the assimilation lamp 240 is placed in the lamp holder 270 and screwed in, it will make electrical contact at a certain time. It has been found that this electrical contact is already achieved when a large part of the lamp cap 242 is still outside the lamp holder 270. FIGS. 2a and 2b show a gasket 200 which is arranged around the lamp cap 242. The gasket 200 covers part of the lamp cap 242. Due to the presence of the gasket 200, a substantial part of the lamp cap 242, which is outside the lamp holder 270, is covered when an electrical contact is established while an assimilation lamp 240 is being fitted, thus significantly reducing the danger zone. According to the invention, the gasket 200 ensures that the part of the lamp cap which is still outside the lamp holder 270 cannot contact the finger of a fitter. The sleeve surface of the lamp cap 242 is covered by the gasket 200 in such a manner that the lamp cap 242 can no longer be touched when the assimilation lamp is being screwed in.

FIG. 2b shows an assimilation lamp which is placed in the lamp holder 270. The lamp cap of the assimilation lamp 240 is no longer visible from the outside. It is completely covered by the gasket 200. The gasket 200 is made of an elastic material, for example rubber. The material of the gasket 200 is also heat resistant and electrically insulating, so that the gasket provides sufficient protection for the fitter even with high-wattage assimilation lamps 240. Many assimilation lamps have a power output of between 200 and 600 watts. In some cases, assimilation lamps having a power output of 1000 watts are also used.

Assimilation lamps in widespread use are, for example, high-pressure sodium lamps with a ceramic discharge tube, which is enclosed by a clear tubular bulb. The light from these assimilation lamps has a high blue content which is suitable for horticultural applications. Another assimilation lamp, for example, is a metal halogen lamp with a quartz discharge tube which is enclosed by a clear tubular bulb. The assimilation lamps are suitable for 230 V single-phase systems or for 400 V phase/phase systems.

FIGS. 3a-3c show in three steps how an assimilation lamp 340 is placed in a lamp holder 370. FIG. 3a shows an assimilation lamp 340 which is situated above an insertion opening of a lamp holder 370. The lamp holder 370 is of a standard type which is commonly used in greenhouse lighting fittings for the European market.

The housing 373 of the lamp holder 370 in this case has a slightly conical shape in the axial direction. Behind the insertion opening, the housing 373 is provided with a cavity into which the assimilation lamp 340 is to be inserted. A contact point 372 is provided at the bottom and establishes contact with the contact point 343 on the lamp cap 342 when the assimilation lamp 340 has been fitted. In addition, a metal outer ring 371 is provided in the cavity of the housing 373, which metal outer ring is provided with a screw thread. During fitting of the assimilation lamp 340, the outer ring 371 contacts the sleeve surface of the lamp cap 342.

The housing 373 is narrower at the bottom than at the opening of the housing. The upper section of the housing 373 has a larger diameter at the location of the insertion opening than the lower section of the housing 373. The outer ring 371 is situated in the central section of the housing 373. In the cavity, the internal part of the housing 373, a widened section is provided in the upper section by means of a groove 374. The widened section 374 tapers in the direction of the bottom of the housing 373. The diameter of the widened section 374 is greater than the diameter of the lamp cap 342. Due to the tapering shape and the fact that the diameter of the widened section 374 is greater, it is simple to position an assimilation lamp 340 in the lamp holder 370. As a result of the difference in diameter between the lamp cap 342 and the widened section 374, a space is created between the housing 373 and the lamp cap 342 during fitting of the assimilation lamp 340.

As FIG. 3a shows, the space between the lamp cap 342 and the housing 373 is filled by means of a gasket 300. The gasket 300 matches the dimensions of the groove 374. The gasket 300 is not completely located inside the housing 373 of the lamp holder 370. A section of the gasket 300 is outside the outer contour of the housing 373. In FIG. 3a, this section corresponds to a guard ridge 301 which is provided near the inner diameter of the gasket 300. The gasket 300 has a through-hole 303, the inner diameter of which substantially corresponds to the outer diameter of the sleeve surface of the lamp cap 342. As a result thereof, the guard ridge 301 closely adjoins the sleeve surface of the lamp cap 342.

In the radial direction, the gasket 300 is provided with a grip ridge 302 which is flexible so that the grip ridge 302 adjoins the housing 373 in a sealing manner, thus resulting in a smooth and sealed finish.

FIG. 3b shows a second step during fitting of the assimilation lamp 340. The lamp cap 342 of the assimilation lamp 340 is inserted into the through-hole of the gasket 300 which is situated in the lamp holder 370. The assimilation lamp 340 has been inserted into the housing 373 of the lamp holder 370 to such an extent that contact is made with the metal outer ring 371 inside the housing 373 of the lamp holder 370. If the voltage is not switched off, the outer ring 371, which is connected to a phase, will be under electrical voltage. As the lamp cap 342 is in contact with the outer ring 341, the lamp cap will also be under voltage. It will be clear that this can lead to undesirable situations if someone who wants to fit a lamp touches the lamp cap 342 with a finger, for example, from that point in time.

As FIG. 3b shows, the presence of the gasket 300 makes the danger zone, which is formed by the exposed part of the lamp cap, inaccessible to the finger of an individual. The height h is so small, for example 1-3 mm, but preferably 2 mm, that a finger is too large to be pushed through the gap which has a height h. The gap having a height h is formed by the end side of the bulb 341, near the lamp cap 342 and the top face of the gasket 300.

The housing 373 opens into a circular wall 375. The inner diameter of the wall 375 is considerably larger than the outer diameter of the sleeve surface of the lamp cap 342. If the gasket 300 were absent, the danger zone would be too large and the finger of an individual could easily be inserted into the space between the end side of the bulb 341, which is situated near the lamp cap 342, and the inner diameter of the wall 375, resulting in the finger touching the lamp cap 342.

FIG. 3c shows how the assimilation lamp 340 can be screwed further into a screw fitting of the lamp holder 370. Because of the elastic properties of the gasket 300, the gasket 300 will give way and seal the housing of the lamp holder 370. As a result, the lamp holder 370 is protected further against the penetration of dirt and moisture.

FIG. 4 shows a cross-sectional view of an embodiment of the gasket 400. The gasket 400 is annular and has a through-hole with a diameter of at least 45 mm, but preferably of approximately 48 mm. The outer diameter of the gasket 400 is at most 65 mm, but preferably approximately 62 mm. The outer contour of the side wall 403 tapers slightly in the axial direction. This geometry of the side wall 403 corresponds to the geometry of the internal part of the lamp holder, so that an accurate fit is achieved. A grip ridge 402 is provided on the side wall 403 which provides additional sealing for the gasket 400 on the housing of the lamp holder. The grip ridge 402 here is designed with an acute angle of approximately 45°. The grip ridge 402 protrudes at least 2 mm in the radial direction with respect to the side wall 403.

The height of the gasket 400 is at least 12 mm. The height of the gasket 400 is increased in the axial direction by a guard ridge 401 which has a height of at least 1 mm. The guard ridge has a width of at least 2 mm and is rounded. The internal diameter of the guard ridge 401 is equal to the internal diameter of the through-hole in the gasket 400.

The gasket is made of silicone and has a hardness of at least 50 Shore A, but preferably of 60±5 Shore A. The silicone material is elastic and electrically insulating. In addition, it is also heat resistant. Insulation has to be provided for high power.

Many variants are possible in addition to the embodiments shown in the figures, all of which are within the scope of protection. In one variant, for example, the cross section of the gasket may be round or rectangular. The gasket may, for example, also be fixedly connected to the lamp holder or assimilation lamp by means of a glue or by vulcanization.

Thus a greenhouse lighting fitting is provided according to the invention, in which the assimilation lamps can be fitted or removed in a safe manner.

1. Greenhouse lighting system comprising a greenhouse lighting fitting having a lamp holder with an outer ring provided in a cavity in the lamp holder, which is electrically connectable to a phase, and via an insertion opening, a screwable assimilation lamp which comprises a lamp cap and a bulb, wherein the greenhouse lighting system furthermore comprises an electrically insulating gasket which is situated around the lamp cap of the assimilation lamp in the greenhouse lighting system in such a manner that the lamp cap can no longer be touched with a finger when the lamp cap contacts the outer ring.

2. Greenhouse lighting system according to claim 1, in which the gasket extends at least partially over the lamp cap between the bulb and the outer ring of the lamp holder.

3. Greenhouse lighting system according to claim 1, in which the gasket at least partly extends as far as into the lamp holder.

4. Greenhouse lighting system according to claim 1, in which the gasket adjoins the lamp cap and the housing of the lamp holder in a sealing manner.

5. Greenhouse lighting system according to claim 1, in which the gasket comprises a guard ridge in the axial direction for at least partially covering the section of the lamp cap which extends outside the lamp holder.

6. Greenhouse lighting system according to claim 5, in which the guard ridge has a height of at least 2 mm in the axial direction.

7. Greenhouse lighting system according to claim 1, in which the gasket comprises a grip ridge on the outer periphery for acting on the lamp holder.

8. Greenhouse lighting system according to claim 7, in which the grip ridge extends at least 2 mm in the radial direction.

9. Greenhouse lighting system according to claim 1, in which the gasket is made of an elastic material.

10. Greenhouse lighting system according to claim 9, in which the gasket is made of silicone having a hardness of at least 50 Shore A.

11. Greenhouse lighting system comprising a lamp holder having a cavity and an insertion opening for inserting an assimilation lamp, in which the lamp holder is provided with a gasket which is situated at least partially in the insertion opening.

12. Assembly comprising a lamp holder and a gasket for use in a greenhouse lighting system according to claim 1.

13. Assembly comprising a lamp holder and a gasket according to claim 12, in which the lamp holder has an insertion opening with a central axis for inserting a lamp cap of an assimilation lamp, in which a gasket is provided around the central axis.

14. Assembly according to claim 12, in which the gasket at least partially extends through the insertion opening in the lamp holder.

15. Gasket for use in a greenhouse lighting system according to claim 1.

16. Assimilation lamp comprising a bulb and a lamp cap, in which the lamp cap is provided with a gasket.
